(19) United States
(12) Patent Application Publication
(10) Pub. No.: US 2016/0103272 A1
(43) Pub. Date: Apr. 14, 2016

(54) Backlight Assembly with Brightness Enhancing Structure

(71) Applicant: Szu-Wei Sun, Pingzhen City (TW)

(72) Inventor: Szu-Wei Sun, Pingzhen City (TW)

(21) Appl. No.: 14/513,266

(22) Filed: Oct. 14, 2014

(51) Int. Cl. F21V 8/00; H01H 13/83

(52) U.S. Cl. CPC G02B 6/0055; G02B 6/0073; G02B 6/0091; H01H 13/83; H01H 2219/044; H01H 2219/06

(57) ABSTRACT

A backlight assembly is provided with an upper reflective layer including a plurality of transparent areas; a lower reflective layer secured to the upper reflective layer; a light guide plate disposed between the upper and lower reflective layers; a light source disposed under the lower reflective layer and corresponding to the transparent areas; a circuit board disposed above the upper reflective layer and including a plurality of first openings and a plurality of electrical contacts; and an opaque shading layer disposed on the circuit board and including a plurality of elastic members aligned with the electrical contacts, and a plurality of second openings. Light with enhanced brightness is transmitted to bottom of keycaps of an input device of a 3C product with energy consumed to a minimum during light transmitting.

### BACKGROUND OF THE INVENTION

1. Field of the Invention

The invention relates to backlight assembly and more particularly to a backlight assembly having a brightness enhancing structure so that light with enhanced brightness is transmitted to predetermined positions (i.e., bottom of keycaps of a keyboard or keypad) of a 3C (computer, communication, and consumer electronics) product with energy consumed to a minimum during light transmitting.

2. Description of Related Art

Backlight is widely used in many electronic products and lights such as keyboards, keypads, notebook computers, mobile phones, remote control and displays. A conventional backlight assembly is comprised of a light guide layer, a reflector plate, a light shading plate and circuit board. The plates are manufactured separately prior to stacking in the manufacturing process. However, energy of the light may be lost gradually as it passes through multi-structure consisting of the light guide plate, the reflector plate, the light shading plate and the circuit board. As such, insufficient light is transmitted to predetermined positions (i.e., bottoms of keycap of a keyboard or keypad) of a 3C product. As a result, backlight efficiency is greatly decreased.

Thus, the need for improvement still exists.

### SUMMARY OF THE INVENTION

It is therefore one object of the invention to provide a backlight assembly comprising an upper reflective layer including a plurality of transparent areas; a lower reflective layer secured to the upper reflective layer; a light guide plate disposed between the upper and lower reflective layers; a light source disposed under the lower reflective layer and corresponding to the transparent areas; a circuit board disposed above the upper reflective layer and including a plurality of first openings and a plurality of electrical contacts; and an opaque shading layer disposed on the circuit board and including a plurality of elastic members aligned with the electrical contacts, and a plurality of second openings.

The above and other objects, features and advantages of the invention will become apparent from the following detailed description taken with the accompanying drawings.

### BRIEF DESCRIPTION OF THE DRAWINGS

FIG. 1 is an exploded view of a backlight assembly according to a first preferred embodiment of the invention;

FIG. 2 is a longitudinal sectional view of the backlight assembly of FIG. 1;

FIG. 3 is a longitudinal sectional view of the assembled backlight assembly of FIG. 1;

FIG. 4 is an exploded view of a backlight assembly according to a second preferred embodiment of the invention;

FIG. 5 is a longitudinal sectional view of the backlight assembly of FIG. 4;

FIG. 6 is a longitudinal sectional view of the assembled backlight assembly of FIG. 4;

FIG. 7 is a longitudinal sectional view of a backlight assembly according to a third preferred embodiment of the invention;

FIG. 8 is a longitudinal sectional view of a backlight assembly according to a fourth preferred embodiment of the invention;

FIG. 9 is a longitudinal sectional view of a backlight assembly according to a fifth preferred embodiment of the invention; and

FIG. 10 is a longitudinal sectional view of a backlight assembly according to a sixth preferred embodiment of the invention.

### DETAILED DESCRIPTION OF THE INVENTION

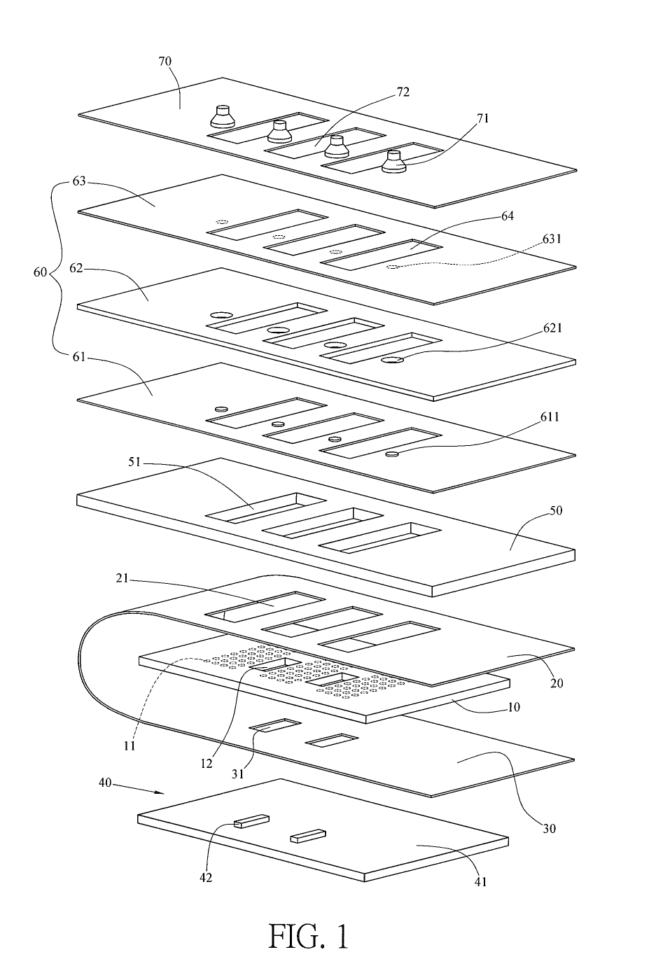

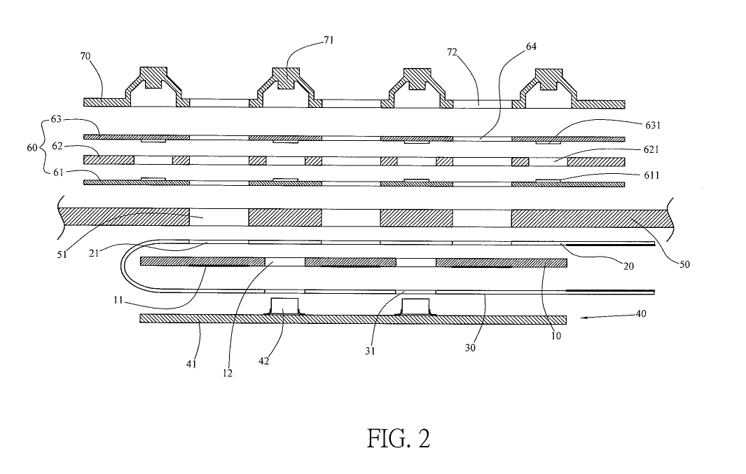

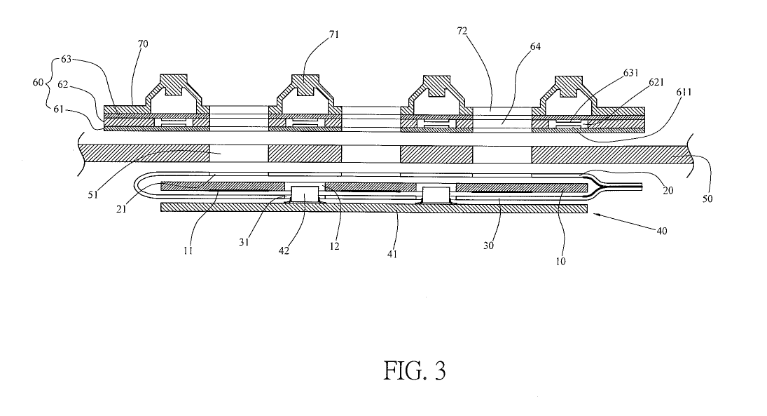

Referring to FIGS. 1 to 3, a backlight assembly in accordance with a first preferred embodiment of the invention comprises the following components as discussed in detail below.

A light guide plate 10, an upper reflective layer 20, and a lower reflective layer 30 are provided. The upper and lower reflective layers 20, 30 are unitary and folded along an intermediate portion of the unitary upper and lower reflective layers 20, 30 to contain the light guide plate 10. Further, ends of the unitary upper and lower reflective layers 20, 30 are adhesively secured together. The upper reflective layer 20 includes a plurality of transparent areas 21. A light source 40 includes a light emitting circuit 41 and a plurality of light-emitting diodes (LEDs) 42 formed on the light emitting circuit 41. The light source 40 is provided under the lower reflective layer 30. The lower reflective layer 30 includes a plurality of openings 31. The light guide plate 10 includes a plurality of openings 12. The LEDs 42 pass through the openings 31 to dispose in the openings 12. Thus, light emitted by the LEDs 42 may pass through the light guide plate 10. Further, the light transmits by means of the upper and lower reflective layers 20, 30. The components of the light source 40 are for description purposes only and are not subject of the invention.

A support plate 50 is provided above the upper reflective layer 20 and includes a plurality of openings 51. A circuit board 60 is provided above the support plate 50. The circuit board 60 is either transparent or opaque (e.g., black). The circuit board 60 includes, from bottom to top, a first circuit board 61, an insulator board 62, and a second circuit board 63. The first circuit board 61 includes a plurality of first electrical contacts 611. The second circuit board 63 includes a plurality of second electrical contacts 631 aligned with the first electrical contacts 611. The insulator board 62 includes a plurality of through holes 621 with both the first and second electrical contacts 611, 631 disposed therein. But the first and second electrical contacts 611, 631 are spaced apart. The circuit board 60 further includes a plurality of openings 64 through each of the first circuit board 61, the insulator board 62, and the second circuit board 63.

An opaque shading layer 70 is provided above the circuit board 60 and includes a plurality of elastic members 71 aligned with both the first and second electrical contacts 611, 631, and a plurality of openings 72 each disposed between two adjacent elastic members 71. A pressing of the elastic member 71 can cause the second electrical contact 631 to contact the first electrical contact 611, thereby completing an electrical circuit indicative of a depressed key (not shown). Top or bottom surface of the opaque shading layer 70 is coated with ink or opaque material.

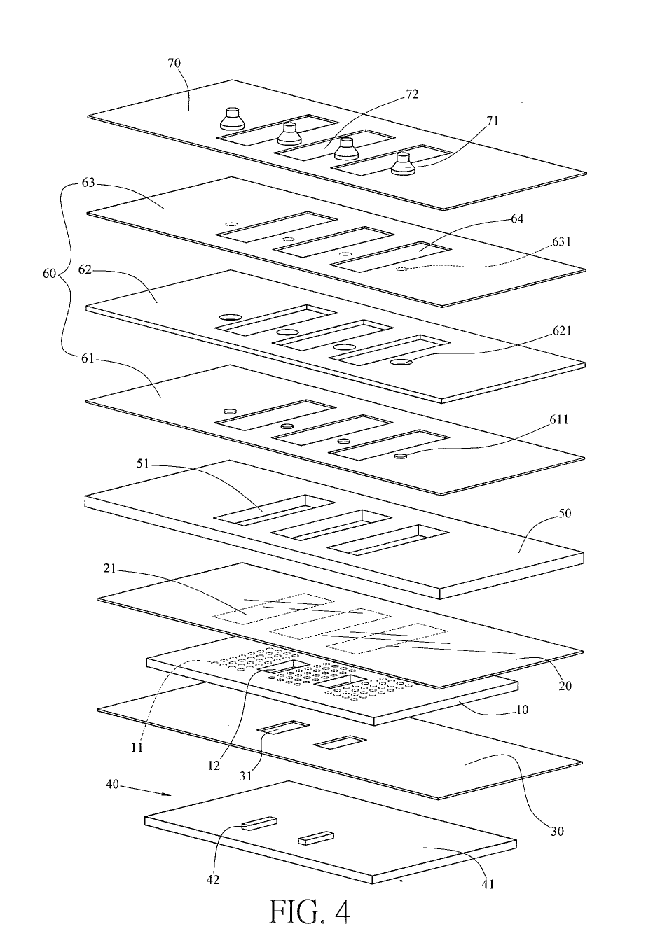

Referring to FIGS. 1 and 4, transparent areas 21 are either through holes or openings. The transparent areas 21 and openings 51 are aligned and communicate each other. Further, the transparent areas 21 and openings 51 are aligned with the openings 64 and 72 or not. Specifically, the transparent areas 21 and openings 51 are aligned with the openings 64 and 72 if the circuit board 60 is opaque. Alternatively, the transparent areas 21 and openings 51 can align with the openings 64 and 72 or not if the circuit board 60 is transparent.

Sizes of the transparent areas 21, openings 51, 64, and 72 are not required to be the same. Preferably, the support plate 50 is made of metal, and the upper and lower reflective layers 20, 30 are formed by folding an intermediate portion of a reflective layer and secured together at ends of the reflective layer with the light guide plate 10 disposed between the upper light guide plate 20 and the lower light guide plate 30. Both the upper and lower light guide plates 20, 30 are opaque. Each of the upper and lower light guide plates 20, 30 are white, silver, or gray. The light guide plate 10 further includes a plurality of reflective areas 11 formed on a bottom surface. The reflective areas 11 are aligned with the transparent areas 21, openings 51, 64, and 72. The reflective areas 11 can change direction of the light prior to passing through the transparent areas 21, openings 51, 64, and 72 to reach predetermined positions (e.g., bottom of keycaps of a keyboard or keypad) for illumination.

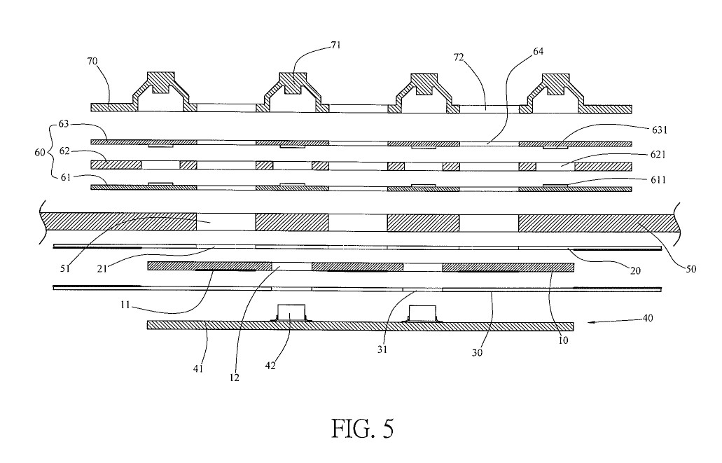

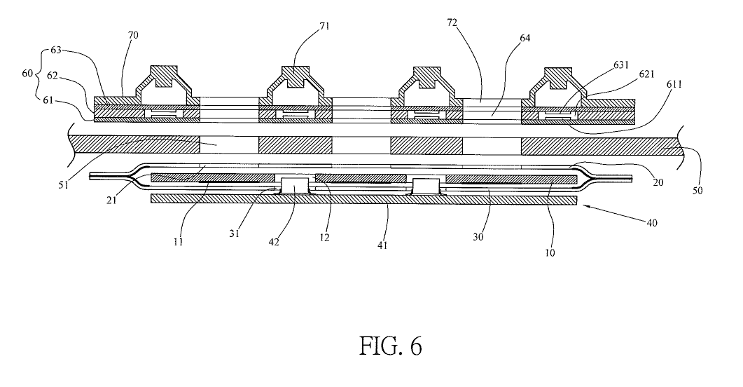

Referring to FIGS. 4 to 6, a backlight assembly in accordance with a second preferred embodiment of the invention is shown. The characteristics of the second preferred embodiment are substantially the same as that of the first preferred embodiment except the following:

The upper reflective layer 20 and the lower reflective layer 30 are unitary respectively. Ends of the upper and lower reflective layers 20, 30 are adhesively secured together, and the light guide plate 10 is concealed by and between the upper and lower reflective layers 20, 30.

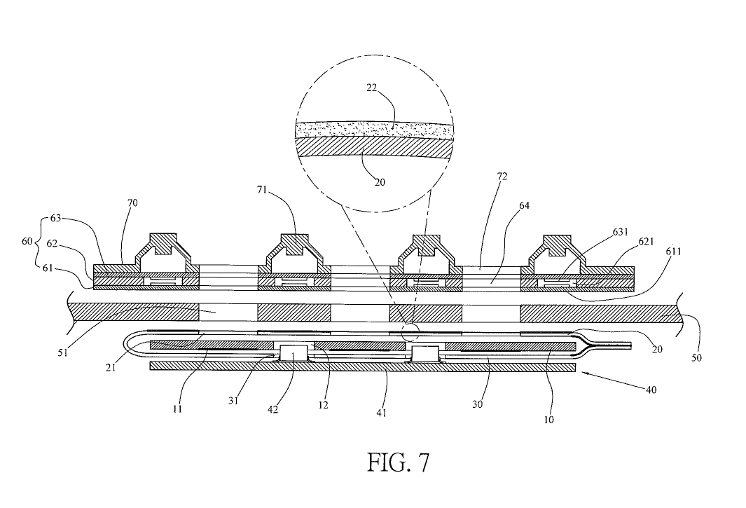

Referring to FIG. 7, a backlight assembly in accordance with a third preferred embodiment of the invention is shown. The characteristics of the third preferred embodiment are substantially the same as that of the first preferred embodiment except the following:

Top surface of the upper reflective layer 20 is coated with a layer of ink 22.

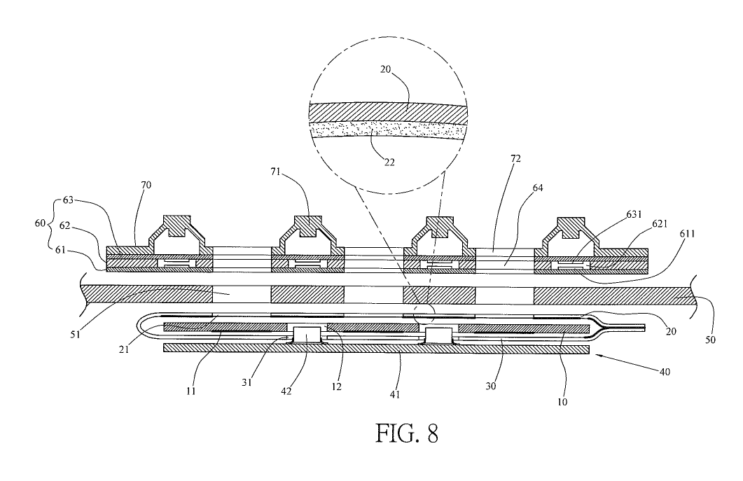

Referring to FIG. 8, a backlight assembly in accordance with a fourth preferred embodiment of the invention is shown. The characteristics of the fourth preferred embodiment are substantially the same as that of the third preferred embodiment except the following:

Bottom surface of the upper reflective layer 20 is coated with a layer of ink 22.

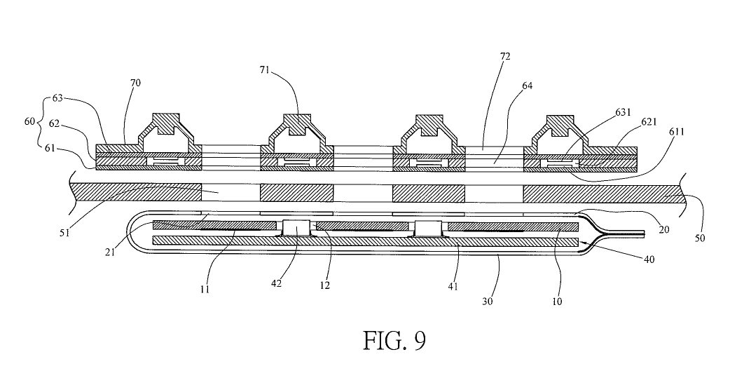

Referring to FIG. 9, a backlight assembly in accordance with a fifth preferred embodiment of the invention is shown. The characteristics of the fifth preferred embodiment are substantially the same as that of the first preferred embodiment except the following:

The lower reflective layer 30 is not provided with openings. The light source 40 is provided between the light guide plate 10 and the lower reflective layer 30 in a spaced manner. Both the light source 40 and the light guide plate 10 are concealed by and between the upper and lower reflective layers 20, 30. The LEDs 42 are disposed in the openings 12.

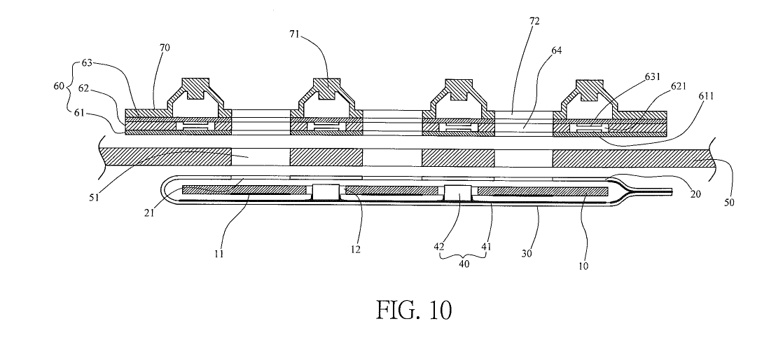

Referring to FIG. 10, a backlight assembly in accordance with a sixth preferred embodiment of the invention is shown. The characteristics of the sixth preferred embodiment are substantially the same as that of the fifth preferred embodiment except the following:

The source 40 is provided under the light guide plate 10 and on the plane with lower reflective layer 30.

It is envisage by the invention that the light guide plate 10 can direct light through the transparent areas 21, openings 51, 64, and 72 to reach predetermined positions (e.g., bottom of keycaps of a keyboard or keypad) for illumination without being blocked by the conventional multi-layer structure. Therefore, energy loss is decreased to a minimum during light transmitting. Light with enhanced brightness is transmitted to the predetermined positions (i.e., bottom of keycaps of a keyboard or keypad) of a 3C product for illumination. Finally, the manufacturing cost is greatly decreased and energy is greatly saved.

While the invention has been described in terms of preferred embodiments, those skilled in the art will recognize that the invention can be practiced with modifications within the spirit and scope of the appended claims.

What is claimed is:

1. A backlight assembly comprising:
an upper reflective layer including a plurality of transparent areas;
a lower reflective layer secured to the upper reflective layer;
a light guide plate disposed between the upper and lower reflective layers;
a circuit board disposed above the upper reflective layer and including a plurality of first openings and a plurality of electrical contacts; and
an opaque shading layer disposed on the circuit board and including a plurality of elastic members aligned with the electrical contacts, and a plurality of second openings.

2. The backlight assembly of claim 1, further comprising a support plate disposed between the upper reflective layer and the circuit board, the support plate including a plurality of third openings.

3. The backlight assembly of claim 1, wherein further comprising a light source disposed under the lower reflective layer and transmitted light corresponding to the transparent areas; wherein the light source includes a light emitting circuit and a plurality of light-emitting diodes (LEDs) formed on the light emitting circuit and disposed through the lower reflective layer; and wherein the light guide plate includes a plurality of fifth openings for receiving the LEDs.

4. The backlight assembly of claim 1, wherein further comprising a light source disposed under the light guide plate and corresponding to the transparent areas; wherein the light source includes a light emitting circuit and a plurality of light-emitting diodes (LEDs) formed on the light emitting circuit, the light source being disposed under the light guide plate and above the lower reflective layer; and wherein the light guide plate includes a plurality of fifth openings for receiving the LEDs.

5. The backlight assembly of claim 1, wherein further comprising a light source disposed under the light guide plate and corresponding to the transparent areas; wherein the light source includes a light emitting circuit and a plurality of light-emitting diodes (LEDs) formed on the light emitting circuit, the light source being disposed under the light guide plate and on the plane with lower reflective layer; and wherein the light guide plate includes a plurality of fifth openings for receiving the LEDs.

6. The backlight assembly of claim 1, wherein each of the second openings are disposed between two adjacent ones of the elastic members; and wherein at one surface of the opaque shading layer is coated with ink or opaque material.

7. The backlight assembly of claim 1, wherein the upper and lower reflective layer are unitary and folded to contain the light guide plate; wherein ends of the upper and lower reflective layers are adhesively secured together; wherein the upper and lower reflective layers are opaque; and wherein each of the upper and lower light guide plates are white, silver, or gray.

8. The backlight assembly of claim 1, wherein the upper reflective layer and the lower reflective layer are unitary respectively; wherein ends of the upper and lower reflective layers are adhesively secured together to contain the light guide plate; wherein the upper and lower reflective layers are opaque; and wherein each of the upper and lower light guide plates are white, silver, or gray.

9. The backlight assembly of claim 2, wherein the light guide plate includes a plurality of reflective areas formed on a bottom surface, the reflective areas being aligned with the transparent areas and the first, second, and third openings.

10. The backlight assembly of claim 1, wherein a portion or all of one surface of the upper reflective layer is coated with ink.

11. The backlight assembly of claim 2, wherein the transparent areas are aligned with the first, second, and third openings if the circuit board is opaque.

12. The backlight assembly of claim 2, wherein the transparent areas and third openings are aligned with the first and second openings or not if the circuit board is transparent.

13. The backlight assembly of claim 2, wherein sizes of the transparent areas and the first, second, and third openings are not required to be the same.

14. The backlight assembly of claim 9, wherein the transparent areas are either through holes or openings.

15. The backlight assembly of claim 11, wherein the transparent areas are either through holes or openings.

16. The backlight assembly of claim 12, wherein the transparent areas are either through holes or openings.

17. The backlight assembly of claim 13, wherein the transparent areas are either through holes or openings.
